(19) United States
(12) Patent Application Publication
(10) Pub. No.: US 2012/0001921 A1
(43) Pub. Date: Jan. 5, 2012

(54) SYSTEM AND METHOD FOR CREATING, MANAGING, SHARING AND DISPLAYING PERSONALIZED FONTS ON A CLIENT-SERVER ARCHITECTURE

(76) Inventors: Marc ESCHER, Les Tavernes (CH); Franz Hoffman, Martigny (CH)

(21) Appl. No.: 13/180,768

(22) Filed: Jul. 12, 2011

Related U.S. Application Data
(63) Continuation of application No. PCT/EP2010/050880, filed on Jan. 26, 2010.

(30) Foreign Application Priority Data
Jan. 26, 2009 (EP) EP09151337

(51) Int. Cl. G06T 11/00

(52) U.S. Cl. 345/467

(57) ABSTRACT

The present invention concerns a method allowing at least an user's device connected to a server (2) to display a text created by an author using a bitmap font, comprising the steps of:
creating said bitmap font by means of a font creation application (1);
storing said bitmap font in said server (2);
synchronizing said bitmap font in said server (2) with a corresponding bitmap font stored in said user's device;
rendering said text in said user's device using said bitmap font in said server (2) and a rendering application (3) run within a browser in said user's device.

The present invention relates also to a system and is a computer program product for creating and sharing personalized font on a client-server architecture.

The present application is a continuation of International Application PCT/EP2010/050880, filed on Jan. 26, 2010, the content of which is hereby included by reference. It claims priority from European Patent Application EP09151337, filed on Jan. 26, 2009, the content of which is hereby included by reference.

The present application is also related to International Applications WO2010084205 and WO2010084207 filed on the same date by the applicant.

### FIELD OF THE INVENTION

The present invention concerns a method and a system for creating, editing, storing, distributing and/or rendering personalized fonts, for example a bitmap font corresponding to the user's handwriting, on a client-server architecture.

### DESCRIPTION OF RELATED ART

With the advent of communication networks, such as the Internet and other private/public networks, computer devices have been used for sharing a wide range of information, from text to images and videos. Wireless networks have extended this scope of connectivity through mobile devices such as smart-phones, personal device assistants or notebooks. Since individuals and businesses now commonly use communication tools such as emails, blogs or chats for various purposes, users require a large degree of control over these messages to convey different intentions.

In this context of massive information exchange, differentiation becomes a key factor. Given that a major part of online communications is text-based, text display customization should be extensive and user-friendly.

Therefore, in text communications, users often put some emphasis on specific words or text blocks, in order to facilitate the legibility of a document or to convey a special meaning. In such a case, users have developed distinct ways to personalize texts: by applying styles, by changing fonts, by altering font properties, or by creating micro-languages such as smileys and short SMS-style language.

Most text-editors feature basic styles such as size, color, underlined, or paragraph alignments. Visual variety is also provided by font choices, which may however be limited to the set of fonts installed on the computer device. Finally, font properties such as spacing, tracking or contextual ligatures may sometimes be applied.

Despite this array of personalization options, text-based applications share some common limitations. The text format has to be set manually for each character, text block, paragraph or selection. It is only through a time- consuming manual process that an end-user can customize the visual appearance of a message. More advanced personalization, for example non parallel paragraphs or text baselines, are usually not possible, although very common and distinctive for handwriting.

The possibilities of personalization with new or unusual fonts, although attractive, are often limited. This in due, in part, to the complexity of current font creation and distribution tools. Drafting and sharing personalized fonts is out of reach for most end-users which therefore have to rely on existing sets of standard fonts.

Font creation solutions exist, but their use is limited to advanced users and professionals and usually requires installation of a comprehensive software package. This in not adapted for casual users. Moreover, even when a new font has been created or updated, it is difficult to distribute it. Current font formats such as TrueType®, OpenType® or Postscript® cannot be used on a device without prior local installation.

A consequence is that most web sites or email clients, for example, only use the very limited number of standard fonts that are installed in most computers and devices.

Solutions such as Embedded OpenType® have been developed in order to distribute and display copyright vector fonts on the web, but the specific subsetting and encryption methods it uses lead to the multiplication and redundancy of font data and files between many devices and websites, to a waste of storage space, and to frequent incompatibility between successive versions of one font.

There are several patents or patent publications in the prior art related to the creation of fonts, including fonts based on handwriting. The following documents are herewith enclosed by references:

FR2807183 describes a method for creating a handwritten font based on a guide grid. This document does not provide any solution for sharing fonts, and requires installation of a dedicated program and fonts on an end-user's device.

U.S. Pat. No. 7,352,899 (“Realistic machine-generated handwriting with personalized fonts”) describes a method for generating a handwritten font, where handwriting variability is randomly simulated. The method applies to vector fonts only. Although vector fonts are easily scalable, they are poorly adapted to the representation of handwriting, since the texture and pressure of the writer cannot be easily represented with vectors.

U.S. Pat. No. 5,412,771 (“Generation of interdependent font characters based on ligature and glyph categorizations”) describes a method for automatic generation of ligatures between characters.

U.S. Pat. No. 6,867,787 (“Character generator and character generating method”) relates to a method for applying three dimensional effects to a font.

U.S. Pat. No. 7,379,075 relates to a method for the representation of colour in bitmap fonts.

U.S. Pat. No. 6,870,535 (“Font architecture and creation tool for producing richer text”) relates to a method of creating a series of font characters represented by a specific hierarchical graph structure.

U.S. Pat. No. 6,958,755 describes a personalized computer font solution using a simplified workflow for personal fonts creation. It is limited to creation of fonts based on letters drawn on a grid. As most current font solutions, it also relies on font technologies that are not appropriate for live communications between different interconnected devices.

US2004091176 describes another method for generating a vector font from characters written in a grid.

U.S. Pat. No. 6,065,008 (“System and method for secure font subset distribution”) relates to a method for creating, signing and distributing fonts and to various methods for authenticating fonts subsets.

U.S. Pat. No. 5,533,174 relates to a method for secure distribution of font stored in a server.

U.S. Pat. No. 6,853,980 describes a system for distributing fonts, where the distance between fonts is computed for facilitating the search.

U.S. Pat. No. 7,009,612 relates to a method for generating fonts based on an existing font.

U.S. Pat. No. 6,975,412 relates to a method for authenticating fonts in order to make sure that the font used during rendering is the same as the font used during the creation of a document.

U.S. Pat. No. 7,188,313 relates to a program for automatic generation of ligature between adjacent characters.

U.S. Pat. No. 5,295,238 relates to another program for automatic generation of context sensitive characters.

WO2006042307 relates to a method for introducing randomness in a vector font, in order to simulate handwriting.

US2003025675 describes a method for simulating handwriting in a vector font, using various parameters such as width, pressure, speed, etc.

U.S. Pat. No. 7,161,598 describes a program for the rendering of fonts, wherein a single file is used for defining a plurality of characters.

None of those solutions provides a method for creating and sharing a new font without installing any dedicated authoring software. Thus, the creation of new font is limited to expert users who have the time and money for purchasing and/or installing a new application in their computer. This is hardly convenient for casual users, for example users who have only one font to create and share.

Especially the creation of a new font from an image, such as a scanned bitmap image, for example, involves advanced methods and user interactions which are usually performed with proprietary software which must be installed in the author's computer.

In addition, none of those solutions provides a convenient method allowing users to produce new original fonts, for example fonts based on their personal handwritings or custom smileys, and immediately use those fonts in messages sent to recipients. In all or most of the prior art solutions, display and use of a font is only possible for recipients who have previously installed this font in their computer systems. This seriously limits the acceptance of the new fonts.

Moreover, even if some services have been proposed to simplify the process of handwritten font creation, the lack of control over the end-result limits the interest of those services and the quality of this result.

Moreover, the creation and the rendering of the fonts are usually performed with two different software programs, which often produce a different rendering.

In addition, the author of a new font has no or limited possibilities for controlling the access rights to his new font, and for deciding which other user or group of users are authorized to use or modify his font.

Therefore, there is a need for a system and for a method that enable users to easily create a new font, for example a font based on handwriting, or based on a scanned image, or any other type of font.

There is also a need for a system and for a method that enable users to immediately use a newly created font in documents or messages that can immediately and easily be read and correctly rendered by any recipient, without any installation of font creation software in the author's device nor in the recipient device, and without explicit installation of the new font in the recipient's device.

There is also a need for a font creation tool which is adapted even to the most casual users, for example users who want to create a new font for one single message, and/or for communicating with one single recipient.

There is also a need for a system and method that enable authors to control which user, or group of users, can use this newly created font and for which purpose.

There is further a need for a system and method that enable authors to create fonts, especially bitmap fonts, which better simulate the handwriting and quality of a rendered text with this font.

There is also a need for a system and method that enable authors to create or edit a font with the same tools, or a similar set of tools, than the software tools used by the receiving user for rendering the font.

A further aim is to fulfill the need for a system that provides more advanced styling features, more flexibility over displayed texts, for example text blocks or text flows and with a greater ease of use for the end-users. They may also be empowered to create custom glyphs to extend existing fonts. This will ultimately lead to more expressive and original displayed texts.

### BRIEF SUMMARY OF THE INVENTION

According to the present invention, these problems are solved by a method allowing at least an user's device connected to a server to display a text created by an author using a bitmap font, comprising the steps of:
creating said bitmap font by means of a font creation application;
storing said bitmap font in said server;
synchronizing said bitmap font in said server with a corresponding bitmap font stored in said user's device;
rendering said text in said user's device using said bitmap font in said server and a rendering application run within a browser in said user's device.

Advantageously, said segmentation and/or a step of the segmentation process may also be performed by an application run within a browser of said author's device.

Advantageously, said segmentation and/or a step of the segmentation process is performed by a Flash®, a Java®, a Javascript®, a HTML5, a Silverlight®, a Cocoa® application or similar technologies.

The use of fonts based on bitmap font described by a bitmap file (i.e., an array of pixels) allows for a more flexible representation of text, since the color of each pixel can be individually controlled. The bitmap that corresponds to each character can be stored in a central server that can be accessed by each authorized user who needs this font to display a text. The rendering of a text with this font is performed by a rendering software in the user's device. In one embodiment, this rendering is performed with an application run in a browser of the user's device, for example based on Flash®, Java®, Javascript®, HTML5, Silverlight®, Cocoa® application or similar technologies. Advantageously, the same piece of software is used for creating a new font and for rendering this font in a browser.

Advantageously, the rendering of the font depends on parameter and/or on code portions defined by the user and that define how the font should be rendered. Those parameters or code portions can for example define the slant of each line, a change of colour or transparency over the text, or other effects that apply to each character, each line, each paragraph and/or each page of the text. They can be stored in the central server and accessed by each rendering application in the users' devices.

Creating the bitmap font file in the author's device allows for a very fast creation and editing process. In particular, performing the image segmentation locally in the author's device is very effective, since the image, and the individual glyphs, stay in the author's device during this process, and do not need to be transmitted to a remote serve. Since, in a preferred embodiment, the whole segmentation is performed by an application run in a browser in the author's device, no application must be installed, so that a new bitmap font can be created within a website, and used or shared from this website.

Advantageously, a box is automatically displayed around each glyph during the segmentation in order to isolate the different glyphs. The author can adapt the segmentation by moving one border or angle of this box. The initial shape of each box around each glyph is preferably automatically computed by the browser application, using for example optical character recognition for recognizing each portion of the image that may correspond to a glyph. The author can also draw new boxes with this application, in order to mark glyphs which are not recognized as such.

Advantageously, each segmented glyph is then associated to a character or a sequence of characters. This association may be automatic, or entirely manual, or preferably based on an automatic process with possibilities for user's corrections. This process preferably occurs in the author's device, preferably using the same application than for segmenting and rendering the fonts.

Advantageously, the manual association between a glyph and a character or sequence of characters is performed by dragging the glyph and dropping it over a key of a virtual keyboard displayed on a screen. A plurality of glyphs can be associated to a plurality of characters in one single operation.

The bitmap fonts created through this process are preferably stored in a central server, and accessed by the rendering application of the users who need to use this font. Local, cache copies of those fonts can also be stored in devices of authorized users.

One author can preferably define access user's rights to a font in order to authorize or prevent other users to use this font. The user's rights can be stored in a Central Server.

A time stamp can be associated with each modification of the user's rights, so that, when a font is disabled or otherwise made unavailable for some users, only earlier message can be displayed with this font but no message created after the font disability.

Performing the segmentation, association and other key steps of the bitmap font creation process in the author's device enables a faster creation and better control over the created font. Storing the resulting bitmap file in a Central Server enables faster, widespread distribution of this resulting font.

The invention concerns also a system for allowing at least a user's device to display a text created by an author including bitmap font comprising an author's device for creating said bitmap font, a network server connected over a network to said author's device and at least an user device for receiving bitmap font from the server, whereby the author's device includes computer program means for receiving and sending information over the network server, means for storing said bitmap font, computer program means for creating said bitmap font and for synchronizing with a copy stored in said server, whereby said server includes means for storing said bitmap font and whereby the user device includes computer program means for receiving information over the network server, means for storing said bitmap font and computer program means for rendering said text and for synchronizing with said copy stored in said server.

Preferably, the server comprises a web/application server running over an operating system of this server.

The present invention has applicability for an author who wants to create new fonts either for its private use or for sharing them with another user or group of recipient users connected together over a network. This user or group of users may select a font in a font collection created by the author on his own device but stored in a central server. For example, the newly created fonts can be immediately applied to emails, web pages and blogs.

An important advantage of the method and system according to the invention is permitting an author to create his own font, this being done for example by scanning his own handwritten writing, and to use it immediately by writing mails or drafting web pages.

The invention concerns also a computer program product comprising a program to be executed by an author's device and/or a user's device and/or a server for causing it to perform the steps of such a method.

### BRIEF DESCRIPTION OF THE DRAWINGS

The invention will be better understood with the aid of the description of an embodiment given by way of example and illustrated by the Figures, in which:

FIG. 1 is a bloc diagram of a system with a client-server architecture for font creation, distribution and storage according to the present invention.

FIG. 2 shows a bloc diagram of a prior art system for creating and sharing fonts.

FIG. 3 shows a flow diagram of a method according to the invention, for creating and sharing fonts in order to use them in messages.

FIG. 4 shows a flow diagram of an alternate method according to the invention for creating and sharing fonts in order to use them in messages.

FIG. 5 shows a flow diagram of a method for creating, processing and using personalized fonts through a service server, according to the prior art.

FIG. 6 shows a flow diagram of another alternate method according to the invention for creating, processing and using personalized fonts from guides.

FIG. 7 shows a possible embodiment of a font creation interface with multiple input sources for font creation, according to the present invention.

FIGS. 8a to 8f show different input sources for font creation.

FIG. 9 shows a possible embodiment of the glyph assignment of multiple input sources according to the present invention.

FIGS. 10a and 10b show a screen copy and a partial screen copy for illustrating an embodiment of graphical user interface (GUI) used for segmenting the glyphs and assisting the segmented glyphs with a character, according to the present invention.

FIG. 11 shows a view of an alternative embodiment of a virtual keyboard according to the present invention.

FIG. 12 shows a view of an alternative embodiment of a virtual keyboard according to the present invention.

FIG. 13 shows a view of an alternative embodiment of a virtual keyboard according to the present invention.

FIGS. 14a to 14d show an example of contextual virtual keypad according to the present invention.

FIGS. 14e and 14f show an example of association of several glyphs with one character or sequence of characters.

FIG. 15 shows a view of an alternative embodiment of the contextual keyboard layout on the virtual keyboard according to the present invention.

FIG. 16 shows a view of an optional preview window of the extracted glyphs for a specific character according to the present invention.

FIG. 17 shows a view of an optional preview bar of all the extracted glyphs according to the present invention.

FIG. 18 shows a possible embodiment of an adjustment/editing process of multiple input sources according to the present invention.

FIGS. 19a and 19b show possible embodiments of the font segmentation and assignment processes for a grid guide input source according to the present invention.

### DETAILED DESCRIPTION OF POSSIBLE EMBODIMENTS OF THE INVENTION

For understanding purposes, a definition of the following words as they are used in this document is provided:
A letter corresponds to a single alphanumerical or non alphanumerical character, to a symbol, pictogram, etc.
A word is a series of letters which may or may not be visually inter-connected. A word usually carries one meaning and is separated from other words by a word separator, for example by a space.
A glyph is an element of writing, i.e. a single portion of an image of a text which contributes to the meaning of what is written. A glyph may correspond to a portion of a letter, a complete letter, an alphanumerical character, a pictogram, a smiley, an emoticon, an ideogram etc.
A ligature corresponds to two or more glyphs which are visually inter-connected, for example when two or more characters are joined in handwriting.
The word text needs to be understood in its broad acceptation. Basically, a text is an ordered set of letters, including alphanumerical or non alphanumerical characters, pictograms, and/or symbols.

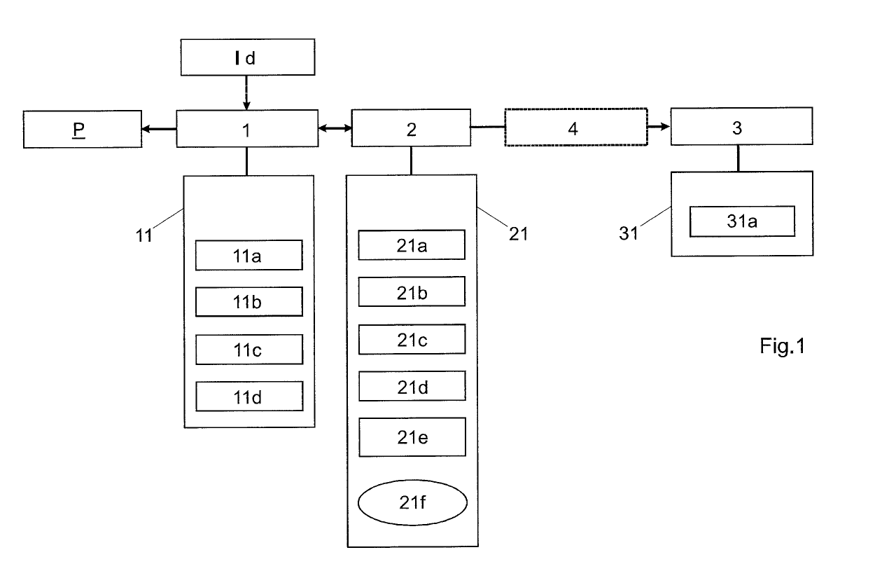

FIG. 1 shows a system for creating and distributing personalized fonts over a network according to the present invention. This system comprises the following elements: a plurality of Font Creation Clients 1, a Central Server 2, possibly associated with a Web/application server 4, and a plurality of Font Display Clients 3. Only one Font Creation Client 1 and one Font Display Client 3 are shown on FIG. 1.

The Font Creation Client 1, the Font Display Client 3 and the Central Server 2 are mutually connected through a network connection such as a local network and/or the

Internet. Fonts created and stored by one Font Creation Client 1 are automatically synchronized with copies stored in a Central Server 2 for access and use by one or several Font Display Client 3. One Font Creation Client 1 is provided to each author who wants to create and share a font. This Font Creation Client 1 comprises a software application, for example a program or preferably a plug-in, which is executed locally in a user device such as a computer, a game station or a mobile communication device. The user device includes a processor, random access memory (RAM), non volatile memory, e.g. ROM, hard disk drive, flash memory and/or similar memories. It also comprises a network input/output which can be implemented as a wireless module or as a network connection, and a display monitor.

Various input devices Id can be connected to the Font Creation Client 1, such as but not limited to a mouse, a stylus, a touch panel, a camera or a scanner. A printer P can be connected in order to print paper grids and other guides used during the creation of a font.

A Local Font Storage 11 stores fonts created with this Client 1. The Local Font storage 11 comprises an input sources database 11a, a font database 11b, a font packages storage 11c and a font file database 11d.

The input source database 11a stores digital images to be processed for retrieving a font. The digital images used as sources may correspond to handwritten text pages, freeform hand-drawn letter sheets, characters in a grid guide, photo images, hand-drawn smileys, etc.

The applications and procedures executed by the Font Creation Client 1 for creating, manipulating and sharing a font are preferably based on a Flash® technology or similar technologies such as Javascript or HTML5 for execution in a web browser such as MS® Internet Explorer for example. In one embodiment, a single application that may be downloaded and run in the browser of author's device is used for performing the different steps which are involved in the creation and sharing of a new bitmap font, as well as the different steps which are required for displaying and rendering a bitmap font. This allows any author or user with a browser and an Internet connection to create and use fonts just by downloading and executing this application within his browser and without any need for installing a dedicated application or font. Moreover, the download may be automatic when the user accesses a particular web page, for example a page with the suitable Flash® code.

Each user who wants to display a font created within the system needs a Font Display Client 3. The Font Display Client 3 comprises a software application, for example a program, a script or a plug-in, executed by a user device such as a computer, a game station, a mobile communication device or any Internet terminal.

One aim of the Font Display Client 3 is to perform the rendering of a text with the bitmap font selected by the author of the text and stored in the Central Database 21 and, possibly, in the Local Cache 31, while taking into account the scripts possibly associated with some fonts for personalizing this rendering. Another aim is to perform the synchronization of bitmap fonts locally stored in the Cache 31 with fonts stored in the Central Server 2. The software in the Font Display Client 3 can be similar or identical to the Font Creation Client 1. The Local Cache 31 contains a font-packages storage 31a used for storing bitmap fonts rendered by the Client 3.

The applications and procedures executed by the

Font Creation Client 1 and by the Font Display Client 3 may be based on the Flash®, Java®, Javascript®, HTML5, Silverlight®, Cocoa® technologies or similar browser-based technologies. The same application may be executed in the Font Creation Client 1 and in the Font Display Client 3. In another embodiment; the software of the Font Display Client 3 is a lighter version of the software in the Font Creation Client 1, and comprises for example only the portions of the code which are required for retrieving and displaying the bitmap fonts, without the portions needed for creating a new font.

The font creation, distribution and rendering applications may also consist of independent applications running on top of the operating system, such as but not limited to an Adobe® AIR™ application. It is noted that any other operating system, such as Apple® OSX™ or Linux® may be used, as well as any application platform, should it be browser-based or not, for example but not limited to MS® Silverlight™ or C++™ applications.

The resources and processing power required for the font creation, storage and rendering of a bitmap font are shared between Font Creation Client 1, the Server 2 and the Font Display Client 3. The font creation process is principally performed on the author's side in the Font Creation Client 1 by an application executed on the author's device, for example within a browser. The font rendering process on the user's side is performed by the Font Display Client 3 with a similar or identical application executed within a browser of the user's device.

Since the same, or a similar, application may be used during the creation and rendering this font, the appearance of this font is the same on the author and user sides.

The application run in the author's and/or client's device, respectively for the Font Creation Client 1 and the Font Display Client 3, is preferably also capable of sending messages, for example emails or contributions to a blog or chat platform, personalized with a bitmap.

Still referring to FIG. 1, the Central Server 2 may be built around a computer server having an operating system, such as but not limited to Microsoft® Windows® NT Server. The Central Server 2 includes a processor, non volatile memory, e.g. ROM, hard disk drive, flash memory, and/or similar memories, a network I/O (input/output) which can be implemented as a wireless module or a network connection, and a display monitor. The Central Server 2 may also be any form of distributed server or virtual machine. The Central Server 2 may run additional image and font processing applications on top of the operating system, such as but not limited to a vectorization application, for processing fonts and text images sent by Fonts Creation Clients 1.

The Central Server 2 comprises or can access a Central Database 21, in which the fonts created by different authors by means of their Font Creation Client 1 are stored, as well as the corresponding access rights.

More precisely, a plurality of files or data are stored in the Central Database 21 during the creation of a new font:
the original input sources database 21a;
the font database 21b, which is a set of bitmap font glyphs at their highest resolution;
a font packages storage 21c for a set of multi-resolution font packages which are automatically down-sampled from the original font, and/or a vector font file;
a font metadatabase 21d in which metadata such as font name, character sets, keywords, spacing, kerning, etc., are stored for each font;
a storage 21e for storing content-file signatures allowing a specific font to be associated with a specific content, for example in order to prevent the use of a particular font with a different content;
an access rights database 21f that stores the font access rights assigned by each author to his fonts. Each font may be associated with font distributor (not shown). A font author may assign specific rights to a font or group of font and to a user or group of users, in order to grant or restrict the right to preview, view, use, copy and/or buy a font.

Scripts may also be associated with some fonts in order to define and personalize the rendering.

The access rights may be assigned by the author using the above mentioned browser-based application and/or later edited or updated using an interface to access to Central Server 2. An author may for example grant private rights to one font that can only be accessed by him, restricted rights for other fonts authorized to users or group(s) of users, or public rights for other fonts which can be accessed by all users. Several combinations of rights may be assigned to a specific font and/or to a specific user through a specific interface. Advantageously, a graphical user interface (GUI) provides the author a series of options to grant rights.

Table 1 shows an example of assignment of rights in the access right database 21f. In this example, an author has the rights which required for viewing, editing his font. This author authorized some users to use one font, but not to duplicate it. Other specific groups may buy the font in order to use it. Finally, all users have at least a right to preview the font, for example in a catalog in the public library.

TABLE 1

| | | Preview | View | Use | Copy |
|---|---|---|---|---|---|
| Private | Author | x | x | X | x |
| | Specific | x | x | X | |
| | users | | | | |
| | Specific | x | x | | |
| | groups | | | | |
| Public | All users | x | | | |

Preview Display a font preview in the font library
View Display messages with the font
Use Enable font usage
Copy Enable font duplication

All fonts are stored in the input sources database 21a, preferably as bitmap fonts. Several successive versions of a font may be stored in the server 2.

Multi-resolution font-packages may also be computed and stored in the font-packages storage 21c of the Central database 21 in order to optimize bandwidth and to provide efficient font data transmission. When a Font Display Client 3 renders a message with a font, it may automatically retrieve and use the font package with the closest resolution to the requested size and quality.

As already mentioned, the fonts stored in the Central Database 21 are synchronized with local copies temporarily stored in Local Font Storage 11 on the author's side, and distributed over the Internet to different Font Display Clients 3; this distribution is for example automatically triggered on demand when one authorized user displays a page, e-mail or document with this font.

Still referring to FIG. 1, the system may comprise a web/application server 4, associated with the Central Server 2. This web server consists of any kind of web server or application server software where a specific set of instructions, provided as plug-ins, DLLs or others, have been implemented. Interconnected between the Central Server 2 and the Font Display Client 3, it makes the fonts stored in Central Database 21 available to a plurality of users for rendering fonts. In one embodiment, the web/application server 4 can also process and forward messages sent by the author(s) to some users.

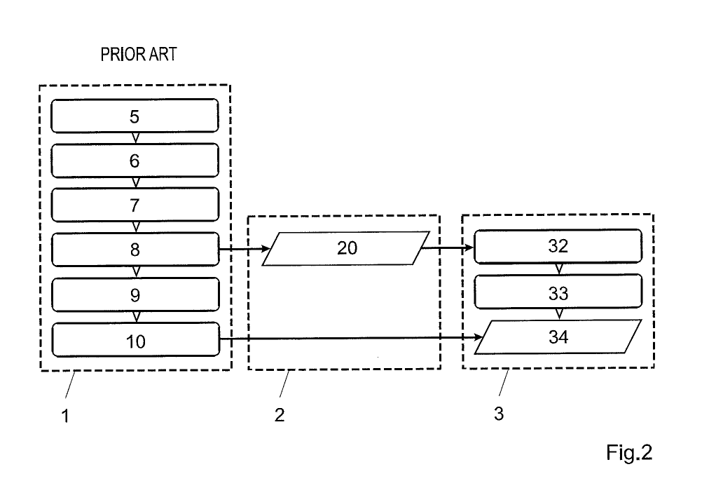

We will now describe some methods which are carried out during the creation, sharing and display of a font. FIG. 2 shows a flow diagram of a prior art method for local creation of a font, and later sharing of the font with other users. In this method, an author who wants to send a message with a new font first needs to draw or import the different letters of the new font (step 5). A font is then locally created and/or edited in the user's device during step 6 in order to generate a font file during step 7. This font is then sent to a Central Server 2 (step 8) where it is stored during step 20. Separately, this font is installed in the author's device during step 9.

In this prior art method, a user 3 who wants to receive and display a text with this new font first needs to download the font from the server 2 during step 32, and install the font in his device during step 33.

A message using the new font can then be prepared and sent by the author during step 10, and displayed with the new font on the recipient side during step 34.

This process is cumbersome and time consuming both for the author 1 and for the recipient 3, who both need to install the font before it can be used. Moreover, this font can only be used by recipients 3 who actively retrieved the font from the server, and successfully installed it.

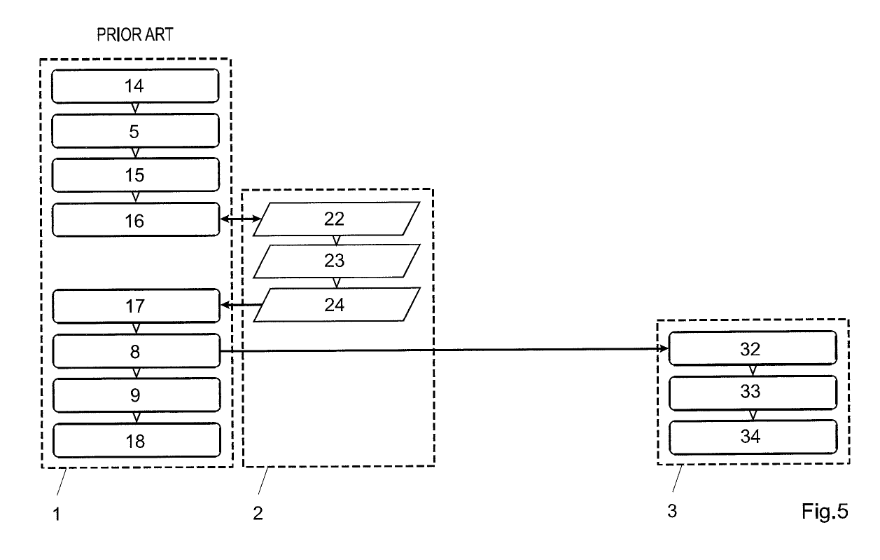

FIG. 5 shows a flow diagram of another prior art method for creating, remotely processing and using personalized fonts. The main difference with the method of FIG. 2 is that, in this case, the new font is generated in a central server.

During step 14 of FIG. 5, a user first prints a grid guide with his printer P, and then fills during step 5 the grid by drawing glyphes, such as letters or other symbols in the boxes of the grid. The grid is then scanned during step 15, and converted into an image file. The position of each glyph in the grid guide corresponds to the character which has to be associated with this glyph.

In the prior art method of FIG. 5, the scanned bitmap image is then sent at step 16 to a server 2. Since a high resolution image is required, a large file needs to be transferred, which is time consuming or even impossible for equipments with slow Internet connection.

The bitmap data received by the server 2 is then processed in the server during step 22, in order to generate a bitmap font at step 23. Processing usually includes segmentation of the image in order to isolate the different glyphs, and association of those glyphs with characters or symbols. In the prior art, this step is usually performed automatically without any user intervention, and based for example on optical character recognition and/or position of the glyphs within the grid.

Therefore, it only works with fonts which are relatively easy to recognize, or at least when optical recognition or use of a grid is feasible.

The font generated at step 23 is then sent back during step 24 to the author's device 1, where it is downloaded at step 17. During step 8, the author 1 then has to send, or make available, a copy of this newly generated font to all other users who needs this font, for example by sending e-mails with the font in attachment, or by uploading this fonts in font repositories over the Internet.

A recipient 3 who receives or retrieves this font during step 32, has to install it during step 33 before he can use it to display messages with this font at step 34. In a similar way, the author 1 also needs to install his own font (step 9) in order to use it (step 18).

This process is very cumbersome for different reasons. First, the transfer of the scanned image to a remote server 2 at step 16 is time consuming and requires a large bandwidth which is not always available. The generation of a font from this image occurs remotely in the server 2 during steps 22 and 23, meaning that the author has little possibilities to control this process and to define which glyph corresponds to which character. The need to send the font in advance and to install it in the devices of all potential users, including the author, makes the sharing of a new font difficult and slow.

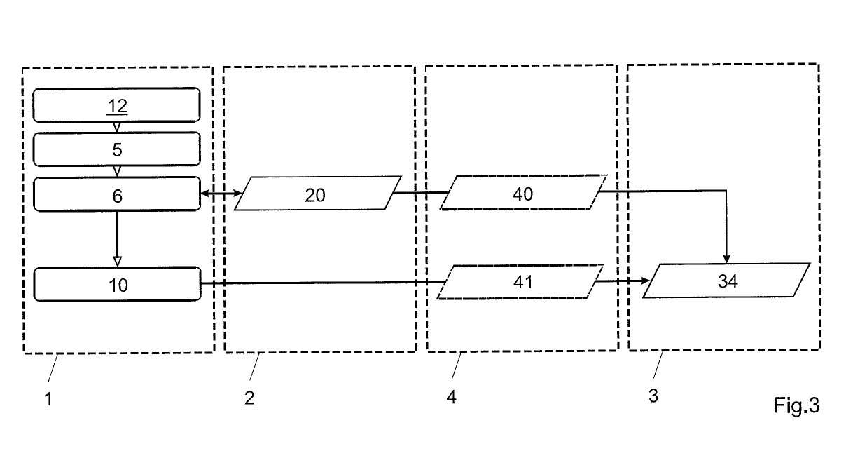

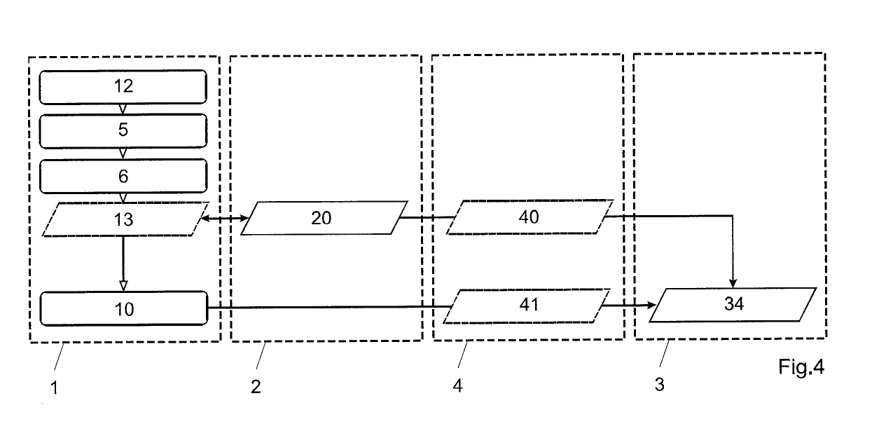

FIGS. 3 and 4 describe two embodiments of the present invention for creating and sharing fonts in order to use them in messages or for rendering text displayed in any document. During step 12, an author who wants to create and use a font first needs to install in his device a Font Creation Client 1, i.e., an application or plug-in. This application can be retrieved from the Central Server 2, or from any other suitable repository, and needs to be downloaded only once for all the subsequent fonts to create or display. This application/plug-in is preferably run in a browser where it is automatically launched when the author accesses a specific address or link on the Internet.

A font is then created within the Font Creation

Client 1 by drawing or importing an image with glyphs (step 5 in FIGS. 3 and 4). The font is then edited and processed (step 6), wherein the processing comprises a segmentation and assignment, as will be described. The font creating and processing of steps 5 and 6 is performed locally in the author's device with the application previously installed or launched during step 12. A message using this new font can then be sent directly from the same application during step 10, for example an e-mail message, a contribution on a blog, a web page, an instant messaging message, etc.

The font created and processed during steps 5 and 6 is automatically sent to a Central Server 2, where it is stored during step 20. A duplicate of the font-packages storage 11c is then stored in the font package storage 21c of the Central Database 21.

The bitmap font stored in the Central Server 2 may be further processed by the author and/or by any other authorized user, using a suitable remote application in the Central Server 2, for example an application available through a web page which can be accessed with the Web server 4 (step 40). This font is also made immediately available to authorized users over this web server 4, and can be immediately used at step 34, for example in order to display messages with this font sent by the author during step 10.

There is thus no need for installing the font in the author and in the recipient device; the font is immediately made available through the Central Server 2, over the Web Server 4, and displayed by any client having previously installed the requested application/plug in.

In order to optimize bandwidth consumption and accelerate font display, font-packages may be cached by the Font Display Client 3 in a local memory 31. Instead of repeatedly fetching the same font package on the Central Server 2, all messages with an identical font will be displayed by using this locally-stored copy of the bitmap font. The Font Display Client 3 then provides a mechanism for synchronizing the local copy of the font with the copy in the Central Storage 2, in order for example to update the font. Thus, new versions of the fonts uploaded in the Central Server 2 are automatically transmitted to the users with a local copy, subject to access rights.

In one embodiment, a subset of glyphs is transmitted from the Central Server 2 to the Font Display Client 3, for example only the glyphs corresponding to the characters which are used in a text to render with this font.

The font-package transmitted to the user's device for rendering of a particular text or for synchronization with the local copy is preferably automatically selected among a plurality of available packages with different resolutions; the Font Display Client 3 automatically retrieves the font with the best resolution needed for the display of the text, depending on the text and on the user's device.

In addition, different versions of the font, corresponding to different languages may be available. The Font Display Client 3 automatically selects the version which is needed, depending on user's selections, on the current language settings of the user, on the language of the text, and/or on the letters or symbols which need to be represented in this text.

In the embodiment of FIG. 4, a local copy of a new font is stored during step 13 in a cache of the author device 1 for faster access and processing. The fonts in this local Cache are later automatically synchronized with the fonts stored in the Central Server 2. This local storage is not performed in FIG. 3, where the new font is immediately transferred to the Central Server 2, and where even the author accesses only the centrally stored version of his font.

The transmission of the new font from the Font Creation Client 1 to the Central Server 2 is preferably automatically performed without any author's intervention, using synchronization mechanisms executed as part of the Font Creation Client 1. The author may nevertheless intervene during this step, for example in order to change the user's rights assigned to this font.

A font will not be deleted from the Central Database 21, modified or otherwise made unavailable after its distribution to any client 3 who used or bought it. Even if one author disables one font at some time, messages previously associated with that font will still be displayable by using a duplicated font-packages storage 21c. A time stamp may be associated with each modification of the font's access rights and with each message, so that only earlier messages can be displayed with this font, but no messages created after the font's disability.

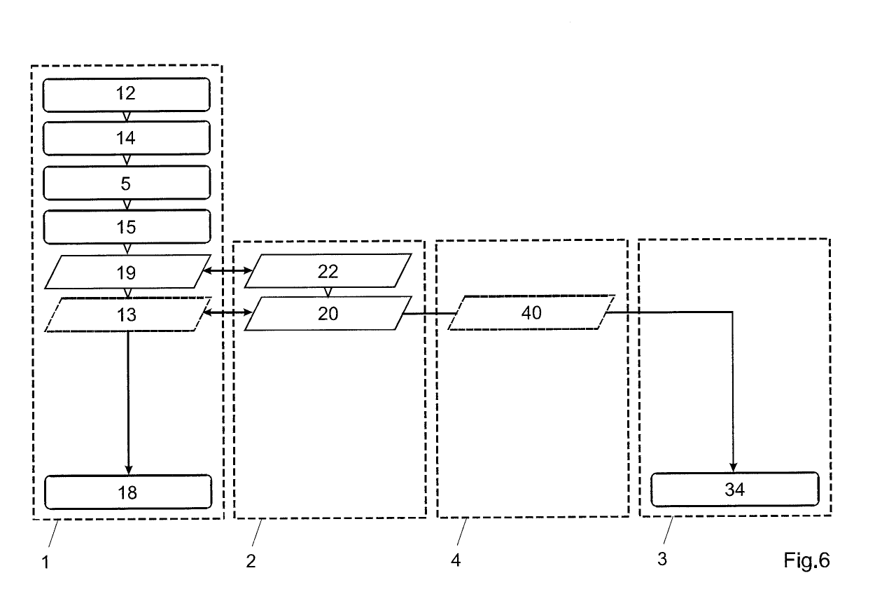

FIG. 6 illustrates another example of font generating and sharing process according to the invention. During step 12, an author downloads from the Central Server 2 or any other repository the Font Creation Client 1, and installs this application in his device, or runs it as a plug-in in a browser. This installation needs to be done only once in a device and the plug-in can for example be executed or made available each time the browser is subsequently started.

During step 14, as in the prior art, the author prints a grid guide with the printer P or retrieves such a grid guide. The grid guide may be printed by using an option or command in the plug in.

The author then draws letters or groups of letters in boxes of the grid guide during step 5. When the grid guide has been completed, it is scanned during step 15, and converted into a bitmap file.

Alternatively, the author can also retrieve images of texts with glyphs by selecting a file otherwise available. The author can also draw or modify glyphs within the plug-in, by using a suitable drawing software.

During step 19, the bitmap image is processed in order to isolate the different glyphs on the page and to associate each glyph with one character or sequence of characters. This processing is advantageously performed locally in the Font Creation Client, i.e, by the very same application/plug in which is used for drawing or importing the bitmap file and later on for sharing and displaying the generated bitmap font.

In one embodiment, some steps of the font generation process are performed in a remote Central Server 2 during step 22. For example, the segmentation of the image into different glyphs, and/or the association between each glyph and or character or sequence of characters, is preferably performed locally in the author's Font Creation Client 1, in order to avoid transfer of large size files. Some subsequent steps can be performed in the server 2, in order to exploit the larger processing power.

The bitmap font which is generated at the end of the process is preferably stored in the author's Font Creation Client 1 during step 13, and automatically sent and synchronized during step 20 with a copy stored in the Central Database 21 of the Central Server 2. This font can also be used immediately for displaying text in the author device, using a bitmap font rendering tool as part of the Font Creation Client/plug-in.

Using the same plug-in, the user can also define user's rights during steps 19-13, and store those rights in the Central Server 2 for defining what other users can do with this font.

After synchronization and definition of user's rights in step 20, the new font is immediately made available at step 40 to other users through the web or application server 4. Other users who need to display a text with this new bitmap font can immediately do this with a suitable Font Display Client 3 that will retrieve this font from the Central Server 2 through the web or application server 4.

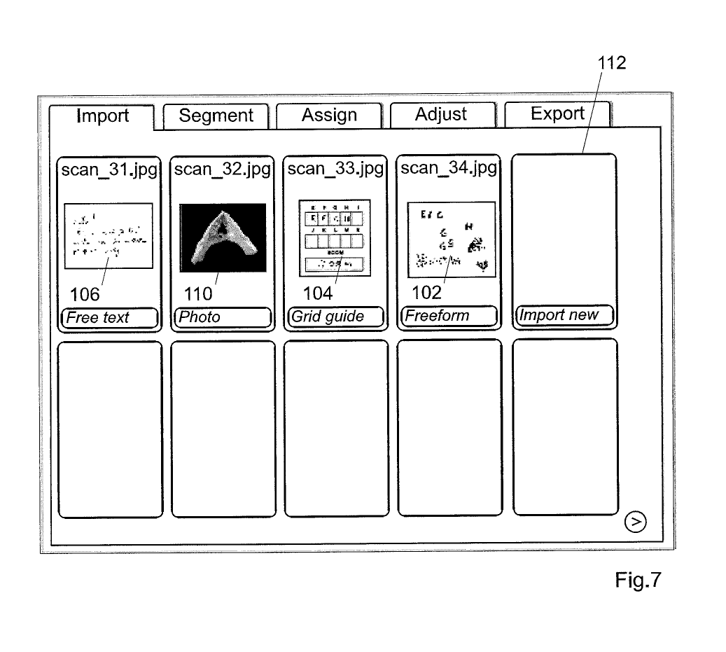

FIGS. 7 to 19b are various screen copies and partial screen copies displayed by the Font Creation Client 1 during the font creation process of the present invention.

FIG. 7 is a screen copy displayed by the Font Creation Client 1 of the author's device during step 19 of the font creation process. The creation of a new bitmap font comprises a plurality of steps which are, in this embodiment, successively performed with various tabs in a window displayed by the Font Creation Client Software application. In the example, the displayed window comprises a first tab titled “Import” for the importation of an image of a text with glyphs, a second tab “Segment” for the segmentation of this image in order to isolate the glyphs, a third tab “Assign” for assigning a character or sequence of characters to a glyph, a fourth tab “Adjust” for the adjustment of the glyph, and a fifth tab “Export” for exporting the created bitmap font.

The first step (importation) consists in the importation of images and/or directly drawing of glyphs within the Font Creation Client 1, by using any device such as a mouse, a tablet, a touch screen or an image scanner for example. The application for importing the image is advantageously run in the web browser of the author's computer, as part of the author's Font Creation Client plug-in. In FIG. 7, the importing window proposes different files which are available from the author's device, namely a free text scan_31.jpg represented by a mosaic 106, a photo scan_32.jpg represented by a mosaic 110, a grid guide scan_33.jpg represented by a mosaic 104 and a free form scan 34.jpg represented by a mosaic 102. The author can freely select one of those images. Other and new images can also be used, including sources in different formats.

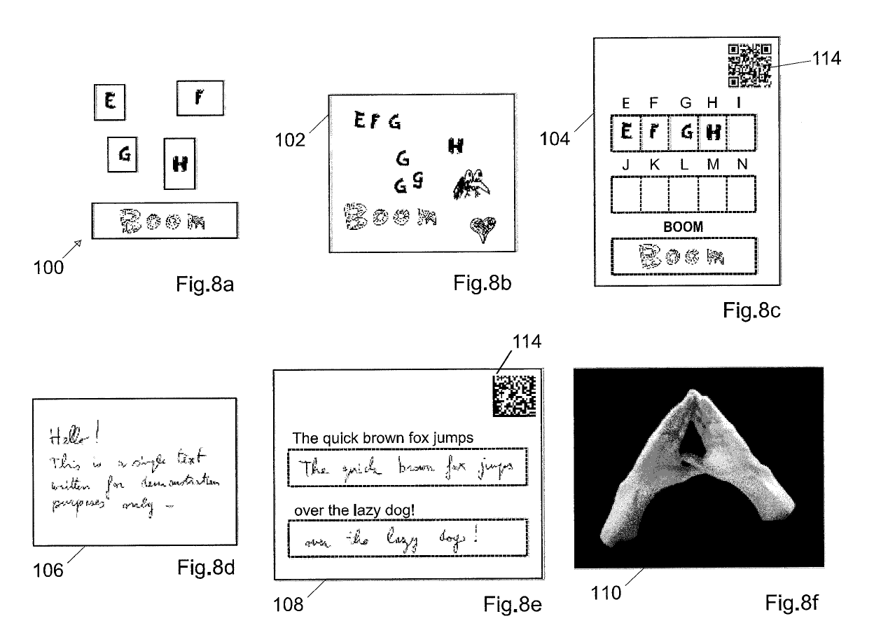

FIGS. 8a to 8f illustrate different examples of images (input sources) that an author may select to create a font. Example of possible images include for example:
separate individual image files 100 (one file for each glyph);
one single hand-written page 102 with characters, numbers, symbols and even drawings;
a grid guide of characters 104, in which one glyph is written in each or some boxes of the grid;
a hand-drawn text page 106;
a guided hand-drawn text page 108;
and/or a photographic picture 110.

Sources with guides may include some specific helper codes such as a Datamatrix or QR Code 114, shown on FIGS. 8c and 8e, in order to identify the specific character sequences and to indicate the orientation of the page. This code 114 can also be used for indicating the type of input source.

Those guides 114 may for example be printed on paper form on which the author draws or writes a new font, and scanned together with the image of the font in order to provide automatic font recognition and orientation.

An author may also combine several glyph creation methods, and/or modify a previously imported glyph. For example, the author may write a free text on a page, scan and import this text into the browser-based application, and modify or clean the scan image using image processing tools provided by the Font Creation Client plug-in and/or by the Central Server 2. The processing of the scanned image may for example include removal of noise, increase of sharpness, adaptation of contrast, rotation and resizing of the image and manual edition of glyphs or glyph parts.

Multiple input sources may also be processed and used for the creation of a single alphabet. To provide a global view of the images to be processed, the author(s) may import several input sources on a single canvas and display them with a preview.

Additional information may also be retrieved from the scanned form and/or entered by the author, including for example the characters to be extracted or the type of segmentation to be used during the next step of the font processing.

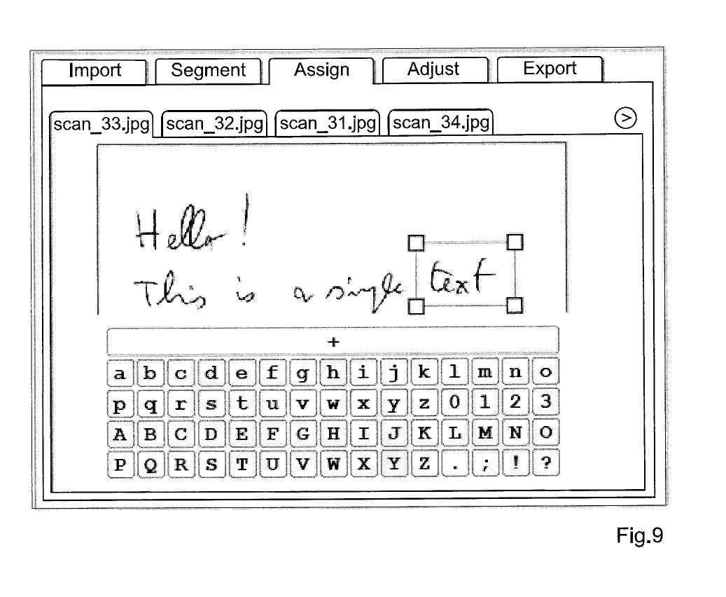

When several sources are edited at any step of the process, they may also be displayed and organized as a series of elements. In one possible embodiment, various sources of one type are displayed on various sub-tabs, with or without a preview icon, or simply by representing the sources by file names scan_31.jpg to scan_34.jpg, as shown in FIG. 9. The lower part of the window of FIG. 9 shows an image of a currently selected sub-tab (here the image scan_33.jpg) as well as a virtual keyboard for assigning glyphs on this image with characters or series of characters.

After the importation, as a second step of the font creation method of the present invention, a segmentation is automatically and/or manually performed in order to identify areas of the image containing the various glyphs. An automatic segmentation may be used when the source is guided, for example based on a grid, while manual segmentation may be preferred for other types of sources. In one embodiment, the Font Creation Client 1 proposes an automatic segmentation, based for example on position in a grid and/or on optical recognition algorithms, and the author can adjust the segmentation in a manual step, if needed.

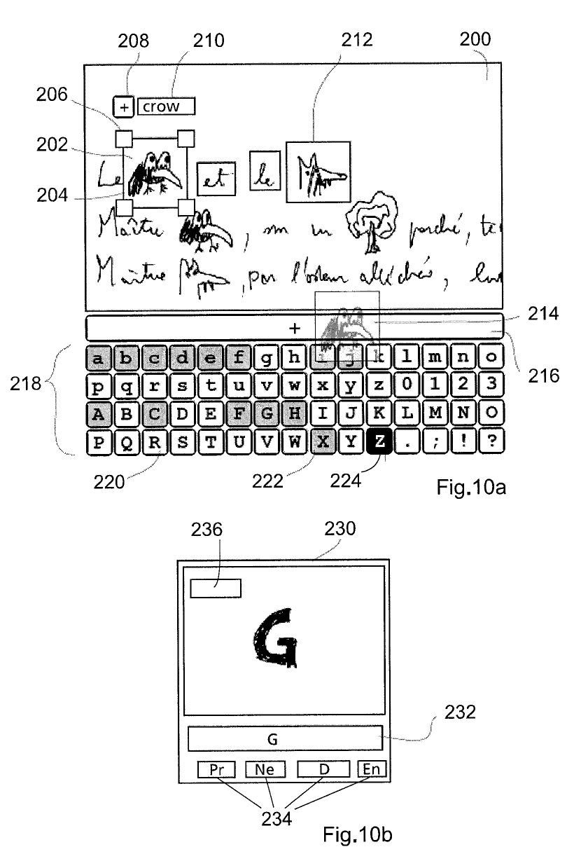

FIGS. 10a and 10b show an exemplary screen copy of a window that may be displayed within the browser by the Font Creation Client 1 during the font segmentation and association process.

After an optional initial automatic segmentation of the selected image into glyphs (if possible), the author(s) may draw and/or adjust the size, shape and position of bounding boxes around each glyph to be extracted. Other shapes instead of this rectangle bounding box may also be used, for instance a lasso tool to delimit a freeform polygon around the glyph.

FIG. 10a illustrates a source image 200 previously imported and selected by the author and which is displayed in a portion of the display. This image typically comprises a plurality of individual glyphs 202 which need to be isolated. Each glyph is delimited by a bounding box 204, 210, 212 or 214. The bounding box 204 comprise handles 206 with which the boxes may be manually modified with a cursor in order to affect the dimension, position and rotation of the box. It is also possible to scale a box 204 in order to adapt the size of the glyph in the box. Once a new bounding box 204 is selected, the other ones 212 are simply visualized with a single stroke without any handles.

After its segmentation, a glyph 202 may then be manually associated with a character or a string of characters by using for example one of the following steps performed by the author:
automatic association, for example based on optical character recognition, or on position in a grid. The character or symbol automatically assigned to a glyph can be corrected by the author.
clicking a specific key 208, for example one key for each bounding box 204, or a key associated with the currently selected box 204, to launch a new preview window 230, as illustrated in FIG. 10b; or
typing the appropriate character(s) on a text field 210 near the currently selected glyph 202; or
dragging a box 214 and dropping it on a “droppable key” 220 linked to a specific character or on a generic key 216 on a virtual keyboard 218 displayed on screen.

In FIG. 10a, the box 214 is dragged and dropped on the generic key 216 which displays a preview window 230 similar to the one shown in FIG. 10b.

During the drag-and-drop process, the image cropped inside the box may be displayed as semi-transparent, as shown by the box 214, or replaced by a smaller icon or specific cursor arrow to facilitate the placement over the virtual keyboard 218. In the same time, droppable keys 224 of the virtual keyboard may be specifically at least temporarily recognizable, for example by highlighting as the box is dragged over them. Once a glyph has been dropped over a virtual key, this key can be made recognizable in another manner, for example differently highlighted as referenced with 222, for the author to notice which keys have already been associated with a glyph.

The preview window 230 of FIG. 10b provides a preview of the cropped glyph image together with a text field 232 in which the author can enter one or several character(s) to associate with this glyph. A box eraser 236 is provided in the preview window 230 for removing noise pixels around the character. This preview window 230 includes additional image modifications options 234 for modifying the glyph, such as a delete key D and navigation keys referenced Pr, Ne En respectively for Previous, Next and Enter to navigate between the successive bounding boxes.

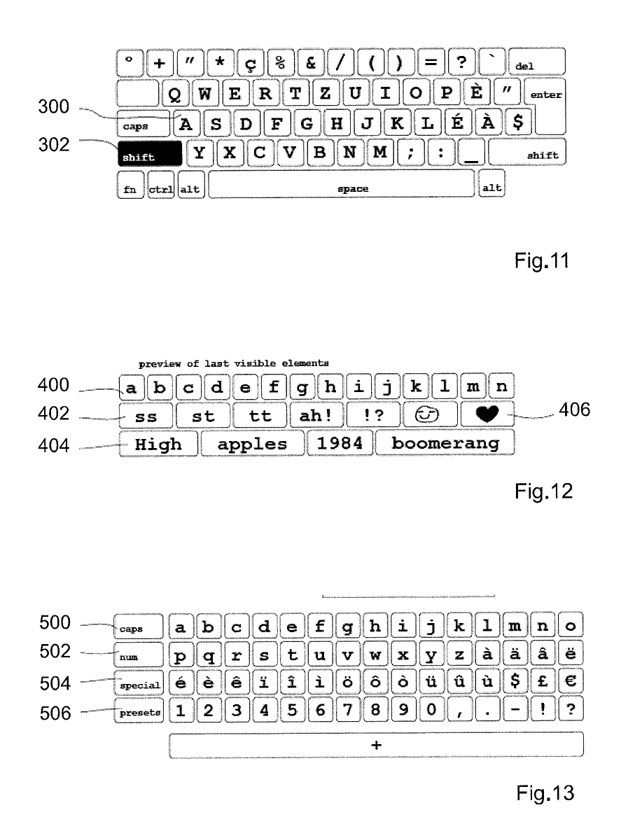

FIG. 11 shows an alternative embodiment of a virtual “droppable” keyboard. The author may change his graphical user preferences in order to select a specific virtual keyboard to be used; this virtual keyboard may be mapped to his physical keyboard and language settings. According to the standard behavior of specific command keys, other keys will be updated to display and assign the related character, for example, as illustrated in this figure, the lowercase “a” key turns into capital “A” 300 as the “Shift” key 302 is pressed.

FIG. 12 shows an alternative embodiment of a virtual keyboard. In this example, the personalized keyboard created by the author features various characters, including alphanumerical symbols 400, non alphanumerical symbols or groups of symbols and multi-level ligatures 402, words 404, symbol 406 or a mix of those.

FIG. 13 shows an alternative embodiment of a virtual keyboard. In this case, keys are alphabetically ordered for authors who are not familiar with keyboard layouts. Additional command keys are provided to switch between different layouts. In some cases this would bring capital letters 500, numerical characters 502, special characters 504 or other user-defined presets 506.

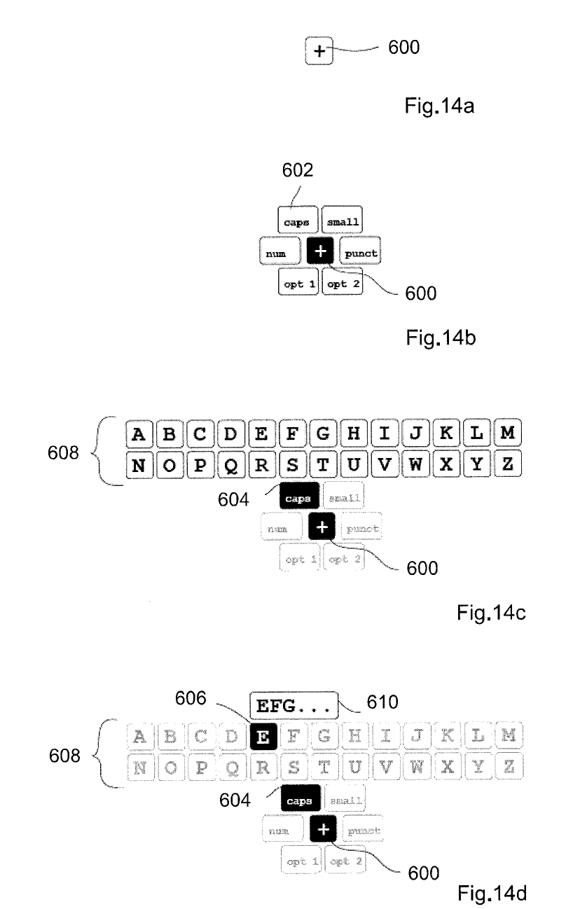

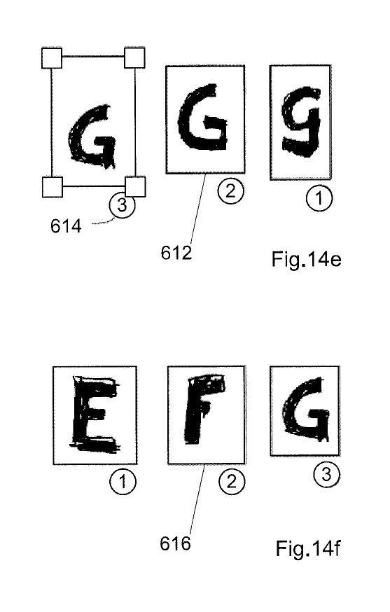

FIGS. 14a to 14d show a contextual interface that may be used for example, but not only, on resolution- limited displays or on keyboard-less systems, e.g. hand-held devices or touch-screens. Instead of using a full blown keyboard, the author navigates through menus from a single key 600 (FIG. 14a) which is progressively completed with additional context-dependent keys 602 (FIG. 14b). When the author drags a glyph on the key or clicks over it, it is presented with a series of extra key categories 602 to choose from, as illustrated in FIG. 14b. As he rolls over a specific one, this one is highlighted, such as the example 604 illustrated in FIG. 14c and another set of droppable keys 608 appears. He may then just drop the glyph on one appropriate key 606, as illustrated in FIG. 14d.

Referring to FIGS. 14e and 14f, in order to accelerate the process, an author can select multiple bounding boxes 612 and associate the corresponding glyphs with one single character or sequence of characters in a single user command.

These boxes may be tagged by an individual number 614 according to their selection order. Therefore, if the different selected boxes represent an alphabetical sequence of characters 612 or 616, the author may drop them over a contextual sequence key 610, as shown previously in FIG. 14d. This key 610, which only appears as multiple boxes have been dragged, symbolizes the first characters of an ordered character sequence.

In FIG. 14f, boxes are dragged over an “E”, the sequence displays “EFG . . . ”. Once dropped, every glyph will be sequentially associated to the next character. For example, first glyph will be associated with the initial character “E”, second glyph with second character “F”, and so on.

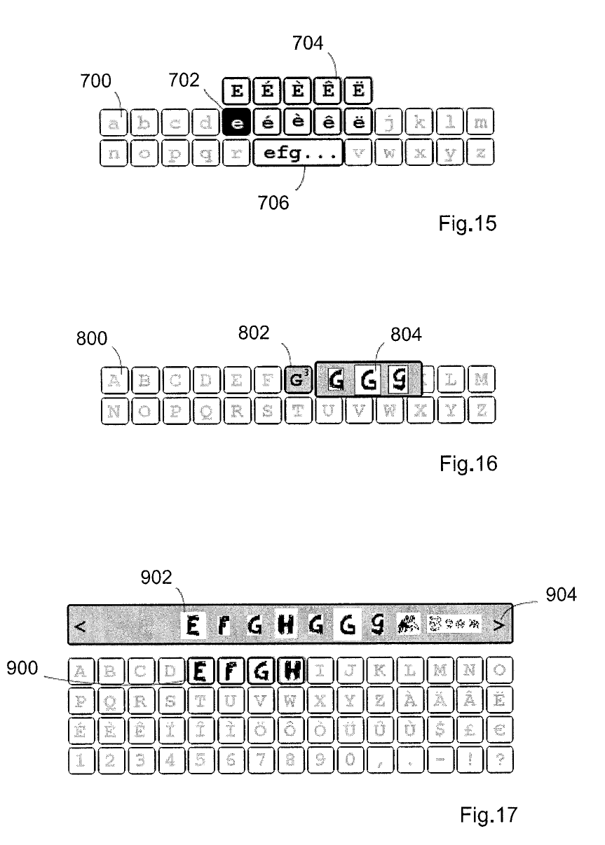

FIG. 15 shows an alternative contextual menu that may pop up from the virtual keyboard keys 700. When the author moves the cursor over a character key 702, it may reveal an additional set of keys 704 which extends the range of assignable characters. For example, this menu may contain accentuated and capital characters derived from a single character, and/or a character sequence 706 which begins by that same character.

FIG. 16 shows a view of an optional preview window of the extracted glyphs associated to a specific character. This window may be displayed on top of the virtual keyboard keys 800. As glyphs are associated to a specific character, the related key 802 may be highlighted to indicate the presence of glyphs, while a number on the key, here 3, would indicate the number of variants. When the author moves its cursor over the key 802, or otherwise selects this key 802, a small window would pop out and display a preview 804 of these various glyphs.

FIG. 17 shows a view of an optional preview bar showing all the extracted glyphs 902 which have already been segmented and/or already been associated with characters. The author may scroll across the different glyphs that may have already been extracted in order to select, reassign or delete them. This may be done with scrolling arrows 904 of the optional preview bar, with a scrollbar, etc. A preview of the glyphs within the keys 900 may also be used.

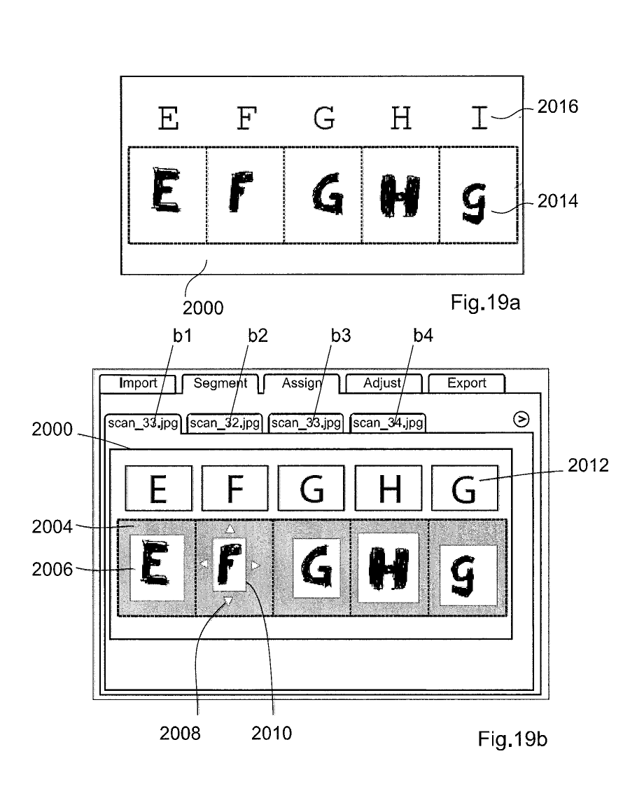

FIGS. 19a and 19b show another possible embodiment of a window displayed during the automatic or semi-automatic font segmentation and assignment processes. This window may be used among other when the input source 2000 uses a grid guide with grid cells 2014 and printed labels 2016. In order to segment the glyphs from a grid, a specific cropping 2004 may be overlaid over the source. An automated process may detect the shape within each grid's cell 2006 and correspondently adjust a cropping area 2010 around each glyph. This cropping area may be manually tuned by the author by sliding a set of handles 2008 which pushes the cropping area inwards or outwards.

If a glyph drawn in a grid guide cell 2014 does not correspond to the label 2016 specified near the cell, this may be corrected by the author by changing the character(s) within an overlaying text field 2012. This field initially contains the original character(s) corresponding to the label 2016.

An author can customize the contextual menus. He can also reorder and rearrange menu items.

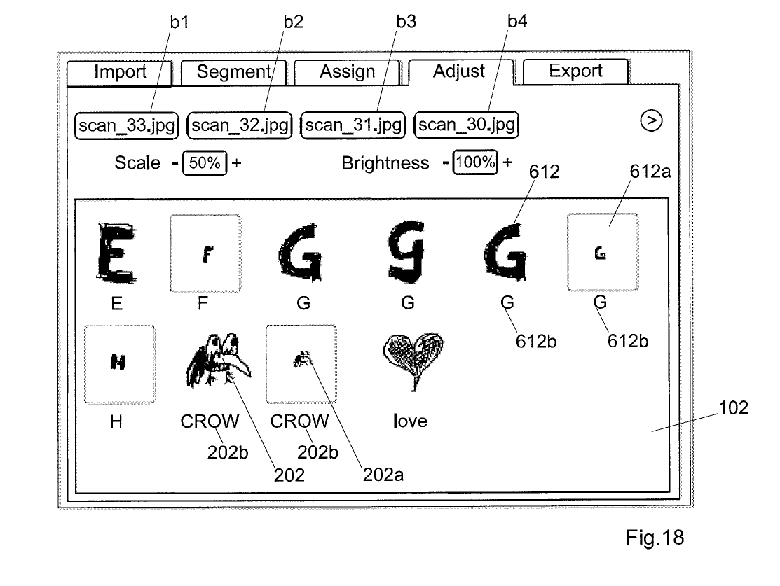

FIG. 18 shows a possible embodiment of the adjustment tab displayed during the font adjustment and editing step. This figure shows the adjustment and editing step of a free form 102, here a hand-written page. Using various tools provided in this tab, an author can for example rescale one glyph using the scaling tool, change its brightness, change its color or manually edit or redraw one glyph. In FIG. 18, the size of characters 202 and 612 has been modified to obtain respectively the characters 202a and 612a. Thus, one author can selectively display and modify glyphs by using image processing functions provided within the application run in the browser.

An author may also perform other operations on the selected glyph(s), such as a global scaling, vertical and horizontal alignment, rotation, removal of noise, improving sharpness, manual editing, etc. Other visual and character-related properties of the glyphs may be modified and processed, for example by removing the background color of a bitmap font, setting inter-letter spacing or vectorizing the glyphs contours.

A font author may also define a specific behavior for a font. Several behaviors may also be accumulated and applied sequentially. A behavior is a specific programming code that affects spatial, visual or temporal features of the glyphs within a text. A non-exhaustive list of the features may include position, scale, rotation, skew, opacity, alternate content source, color shift or blending mode.

For example, one author can define a script which alters the alignment of letters, words and text lines by bending the text flow, in order to reproduce handwritten text flows. Alternatively, the opacity of the text can fade across each glyph to simulate a drying pen on paper.

These features may also have time-based properties. A behavior may be effective on glyphs, words, sentences or paragraphs, and affect them differently, for instance incrementally. A behavior may be set before the user types text, or applied after a text block was selected. Behaviors may be exposed to the user by a series of parameters. Behaviors may be accumulated and applied sequentially. Behaviors may be provided at random or may be manually added to the rendering system, and provided as external programming script codes.

As samples of the different parameters that may be affected and exposed for specific displayed text behaviors, bending lines can be cited in regard of slope, curvature and bending start. Jitter can be also considered, especially for horizontal displacement, vertical displacement, maximum for random translation, maximum for random rotation and maximum for random scale. Parameters concerning the drying ink, i.e. percentage loss and consumption per letter/word/line and parameters concerning the ligatures, i.e. On/Off switch and maximum letters per ligature are also of interest as well as alternates, e.g. contextual alternative glyphs.

The author of a font may thus program specific scripts, for instance in a Flash® application or similar software, in order to apply them to a displayed text. This also allows to use bitmap fonts and to process additional image-based visual effects, such as but not limited to a blur, sharpening or coloring of the glyphs.

1. A method allowing at least an user's device connected to a server to display a text created by an author using a bitmap font, comprising the steps of :
creating said bitmap font by means of a font creation application on an author's device;
storing said bitmap font in said server;
synchronizing said bitmap font in said server with a corresponding bitmap font stored in said user's device;
rendering said text in said user's device using said bitmap font in said server and a rendering application run within a browser in said user's device.

2. The method of claim 1, wherein said font creation application is run within a browser in the author's device connected to said server.

3. The method of claim 2, wherein a single application is used for creating new fonts, for synchronizing those new fonts with said server, and for rendering texts with existing fonts stored in said server.

4. The method of claim 1, wherein said font creation application is based on a Flash®, a Java®, a Javascript®, a HTML5, a Silverlight®, or a Cocoa® application.

5. The method of claim 1, comprising:
storing said bitmap font is stored in a cache of said user's device;
retrieving said bitmap font from said cache using said rendering application.

6. The method of claim 5, including a step of synchronization of said bitmap font in said server with said bitmap font in said cache by means of said rendering application.

7. The method of claim 5, wherein said rendering application periodically checks whether said bitmap font has been updated in said server; and
wherein said rendering application synchronizes said bitmap font in said server with said bitmap font in said cache when an update is available.

8. The method of claim 6, wherein a plurality of successive versions of one bitmap font are simultaneously or successively stored in said server, wherein uploading of a new version of a bitmap font by said user triggers synchronization of this new version of the bitmap font into said user's device.

9. The method of claim 1, comprising:
synchronizing said bitmap font in said server with said bitmap font in a cache of said author's device by means of said font creation application.

10. The method of claim 1, wherein said author assigns rights to said user in order to authorize or prevent said user to use said bitmap font.

11. The method of claim 10, wherein said rights are stored in said server.

12. The method of claim 11, wherein said rights are verified each time when said bitmap font is used by said user, and wherein a replacement font is used when said user is prevented to use said bitmap font.

13. The method of claim 10, wherein a graphical user interface displayed by said author's device provides said author a series of options to grant said rights.

14. The method of claim 1, wherein the step of synchronization between said bitmap font in said author's device and said bitmap font in said server is automatic; and
wherein the step of synchronization between said bitmap font in said user's device and said bitmap font in said server is automatic.

15. The method of claim 10, wherein a time stamp is associated with each change of said user's rights assigned to said bitmap font; and
wherein the display of said text with said bitmap font on the user's device depends on said time stamp.

16. The method of claim 1, wherein during said rendering step said rendering application choices a bitmap font package between the multi-resolution font-packages stored in said server having a resolution requested for displaying said text on the user's device.

17. A system for allowing at least a user's device to display a text created by an author including bitmap font comprising
an author's device for creating said bitmap font,
a network server connected over a network to said author's device and
at least an user device for receiving bitmap font from the server,
whereby the author's device includes computer program means for receiving and sending information over the network server, means for storing said bitmap font, computer program means for creating said bitmap font and for synchronizing with a copy stored in said server,
whereby said server includes means for storing said bitmap font,
and whereby the user device includes computer program means for receiving information over the network server, means for storing said bitmap font and computer program means for rendering said text and for synchronizing with said copy stored in said server.

18. A computer program product comprising a program to be executed by an author's device and/or a user device and/or a server for causing it to perform the steps of the method according claim 1.

19. A method of rendering a text on a user's device using a bitmap font, comprising the steps of:
detecting that said bitmap font is required for rendering a text;
synchronizing a local copy of the bitmap font stored in said user's device with a remote copy of the font stored in a remote server;
rendering said text in said user's device using said local copy of the bitmap font and a rendering application run within a browser in said user's device.
